(19) United States
(12) Patent Application Publication
(10) Pub. No.: US 2021/0262755 A1
(43) Pub. Date: Aug. 26, 2021

(54) Hot Equipment And Thermal Reduction System

(71) Applicants: Frank J. Michal, Medina, OH (US); Michael E. Stein, New Philadelphia, OH (US)

(72) Inventors: Frank J. Michal, Medina, OH (US); Michael E. Stein, New Philadelphia, OH (US)

(21) Appl. No.: 17/065,786

(22) Filed: Oct. 8, 2020

Related U.S. Application Data
(60) Provisional application No. 62/979,173, filed on Feb. 20, 2020.

(51) Int. Cl. F41C 33/06; B32B 5/02; B32B 17/02; B32B 19/06

(52) U.S. Cl. CPC F41C 33/06; B32B 5/024; B32B 17/02; B32B 2250/20; B32B 2307/304; B32B 2250/03; B32B 19/06

(57) ABSTRACT

Described in an example embodiment herein is a system for hot equipment and thermal mitigating that can be employed for weapon or firearm storage, such as for example carrying bags, weapon barrel bags, suppressor bags and pouches or any thermally conductive equipment and/or accessories relating to firearm or weapon systems. The system comprises a multi layered system of non-thermally conductive materials arranged in a manner to mitigate heat transfer and/or shield or mask a thermal signature. The arrangement of the aforementioned materials comprises a hot face contact layer, an insulating layer, a reflective layer and a flexible, semi-flexible or hard outer shell that can be configured in any shape or pattern to produce products, such as, including but not limited to a weapon storage case, carrying bags, barrel bags, suppressor pouches or any thermally conductive equipment and or accessories relating to firearm or weapon systems.

### CROSS REFERENCE TO RELATED APPLICATIONS

This application claims the benefit under 35 U.S.C. § 119 of U.S. Provisional Application No. 62/979,173, filed Feb. 20, 2020. The contents of the aforementioned application are hereby incorporated by reference herein in its entirety.

### TECHNICAL FIELD

The present disclosure relates generally to hot equipment and thermal mitigating storage accessories, such as, for example weapon or firearm storage or carrying bags, weapon barrel bags, suppressor bags and pouches or any thermally conductive equipment and or accessories relating to firearm or weapon systems.

### BACKGROUND

Thermal mitigation may be employed to protect users from extreme temperatures and enhance user safety when handling hot devices, such as firearms. Thermal mitigation may also be useful in situations where a thermal signature needs to be masked.

### SUMMARY OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus comprising a hot face contact layer, an insulating layer coupled with the hot face contact layer, and a reflective layer coupled with the insulating layer. The reflective layer is configured to reflect heat towards the insulating layer.

### BRIEF DESCRIPTION OF THE DRAWINGS

The accompanying drawings incorporated herein and forming a part of the specification illustrate the example embodiments.

FIG. 1 illustrates an example of layers employed in a Hot Equipment And Thermal Reduction System.

FIG. 2 illustrates an example backpack that employs layers of the Hot Equipment and Thermal Reduction System illustrated in FIG. 1.

FIG. 3 illustrates an example of a carrying case that employs layers of the Hot Equipment and Thermal Reduction System illustrated in FIG. 1.

FIG. 4 is an external view of the gun carrying case illustrated in FIG. 3.

FIG. 5 illustrates an exploded view of the area bound by circle 44 in FIG. 4.

FIG. 6 illustrates an internal view of carrying case with multiple pockets/compartments that employs layers of the Hot Equipment and Thermal Reduction System illustrated in FIG. 1.

FIG. 7 illustrates an example of a carrying case configured to carry a rifle that employs layers of the Hot Equipment and Thermal Reduction System illustrated in FIG. 1.

FIG. 8 illustrates another example of a carrying case configured to carry a rile that employs layers of the Hot Equipment and Thermal Reduction System illustrated in FIG. 1.

FIG. 9 is a perspective view of yet another example of a carrying case configured to carry a rifle that employs layers of the Hot Equipment and Thermal Reduction System illustrated in FIG. 1.

FIG. 10 is another perspective view of the carrying case illustrated in FIG. 9.

FIG. 11 is a perspective view of the carrying case illustrated in FIG. 9 with a different type of rifle.

FIG. 12 is another perspective view of the carrying case illustrated in FIG. 11.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment, described herein his system referred to as the HEAT-RS (Hot Equipment And Thermal Reduction System) that is a multi-layered system of non-thermally conductive materials arranged in a manner to mitigate heat transfer and/or shield or mask thermal signature to the outside surface of the HEAT-RS. The arrangement of materials comprises a hot face contact layer, an insulating layer, a reflective layer and a flexible, semi-flexible or hard outer shell.

The materials can be configured in any shape or pattern to produce a product that fulfills a specific requirement such as but not limited to a weapon storage case or carrying bags, barrel bags, suppressor pouches or any thermally conductive equipment and or accessories relating to firearm or weapon systems. In an example embodiment, the materials are arranged in the aforementioned order.

In an example embodiment, the hot face material is used in a manner that lines the internal surfaces of the storage system and encapsulates the hot equipment stored within the HEAT-RS. In an example embodiment, the hot face material comprises a combination of either woven textile or molded materials, for example, including but not limited to fiberglass, silica, silicon, Kevlar, stainless steel in any combination. In particular embodiments, the hot face layer can withstand extreme temperatures in excess of 2000F and will interface with an insulating layer, which acts as a buffer between the hot face layer and the remaining layers of the HEAT-RS.

In an example embodiment, the insulating layer will also comprise materials such as, including but not limited to, fiberglass, silica, silicon, Kevlar produced in a woven pattern, which, creates a loose cushion like weave incorporating air pockets in and around the said materials.

In an example embodiment, working in conjunction with and in a specific arrangement to the hot face and insulating layer is a reflective layer. The reflective layer can also consist of materials such as, including but not limited to, fiberglass, silica, silicon, and/or Kevlar that when coupled with the insulating layer will reflect heat back into the HEAT-RS, thus producing a cold face surface to which other materials can be mated. The cold surface external mating layers can be made of any type of flexible or rigid materials such as but not limited to cordura, nylon, cotton, canvas or polymer. The specific arrangement of the hot face layer, insulation layer and reflective layers of material as well as an outer shell produce a thermal mitigating barrier so that an individual can safely handle hot objects and reduce their thermal and infra-red signatures.

The thermal mitigation from the HEAT-RS protects users from extreme temperatures and enhances the safety of the user. The thermal mitigation achieved by the HEAT-RS also creates a thermal and visual barrier, which is an advantage to the user when fielded in specific environments where thermal signatures need to be masked.

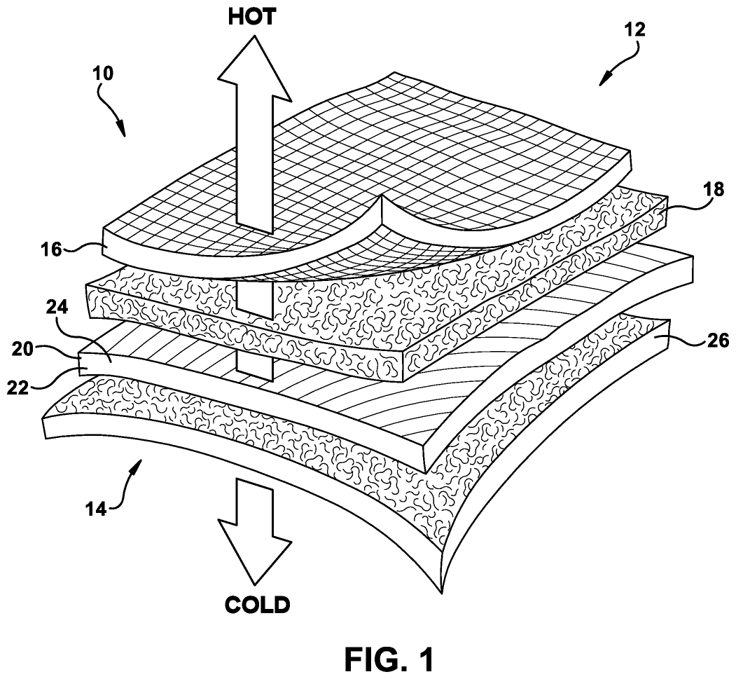

FIG. 1 illustrates an example of layers employed in a Hot Equipment And Thermal Reduction System 10 in (HEA-RS) accordance with an example embodiment. The HEAT-RS 10 comprises a first side 12 that is also referred to herein as the hot side, and a second side 14 that is also referred to herein as the cold side.

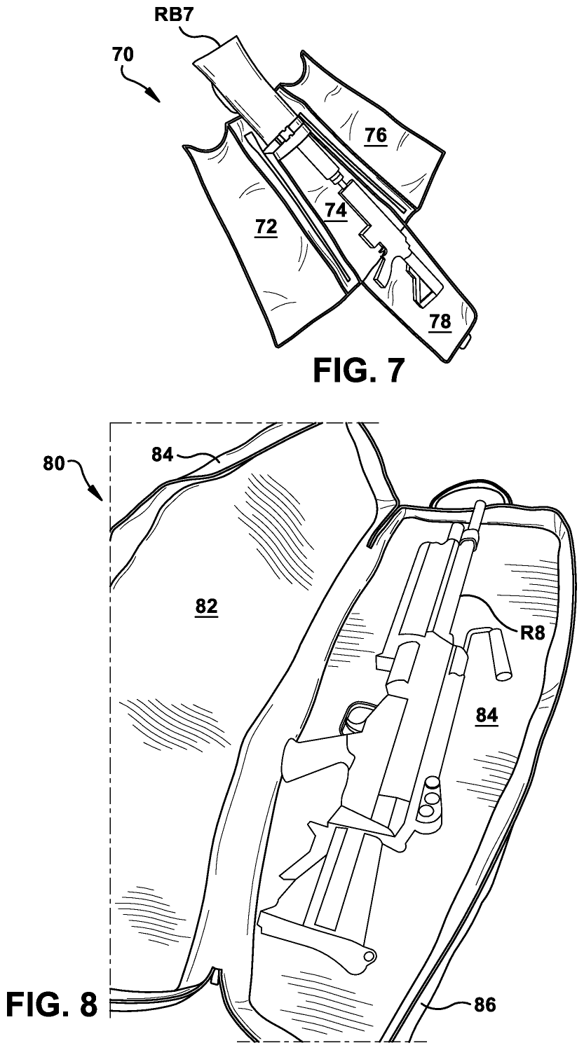

The hot face contact layer 16 is located adjacent to the hot side 12. The hot face contact layer 16 is intended to interface with a heated object (not shown, see e.g., FIGS. 7-12) such as a firearm or firearm barrel. The hot face contact layer 16 can either be in contact with the heated object or can partially or fully encompass a heated object. In an example embodiment, the hot face contact layer 16 comprises a material or a combination of either woven textile or molded materials. Examples of material suitable for the hot face contact layer 16 include, but not limited to fiberglass, silica, silicon, Kevlar, stainless steel in any combination. In particular embodiments, the hot face layer can withstand extreme temperatures in excess of 2000F and will interface with an insulating layer, which acts as a buffer between the hot face layer and the remaining layers of the HEAT-RS 10.

The insulating layer 18 is coupled with the hot face contact layer 16. the insulating layer 18 acts as a buffer between the hot face contact layer 16 and the reflective layer 20 and any remaining layers of the Heat-RS 10.

The insulating layer 18 can comprise any suitable insulating materials such as but not limited to fiberglass, silica, silicon, and Kevlar. In an example embodiment, the insulating material is produced in a woven pattern, which creates a loose cushion like weave incorporating air pockets in and around the insulating materials

The reflective layer 20 is coupled with the insulating layer 18. As those skilled in the art can readily appreciate, the reflective layer 20 can be formed of any heat reflecting material 22, such as for example aluminum that can be in the form of aluminum foil, fabric or laminates. Copper is another material suitable for the reflective layer 20. Other embodiments can employ a metalized thin firm, fabric or laminate. Still yet other embodiments can employ direct-metalized (non-laminate) fabric.

In particular embodiments the reflective layer 20 further comprises one or more materials 24 such as, including but not limited to, fiberglass, silica, silicon, and/or Kevlar bonded to the heat reflecting material 24 that when coupled with the insulating layer 16 will reflect heat back into the HEAT-RS 10, thus producing a cold face surface to which other materials can be mated.

In an example embodiment, the HEAT-RS 10 further comprises outer layer 26 that is also referred to herein as an outer shell or cold surface mating layer. The outer layer 26 can be a flexible, semi-flexible or hard material. For example the outer layer 26 can be made of any type of flexible or rigid materials such as but not limited to cordura, nylon, cotton, canvas or polymer. In particular embodiments, the specific arrangement of the hot face layer 16, insulation layer 18 and reflective layers of material 20, as well as an outer shell 26 produce a thermal mitigating barrier to which an individual can safely handle hot objects and reduce their thermal and infra-red signatures.

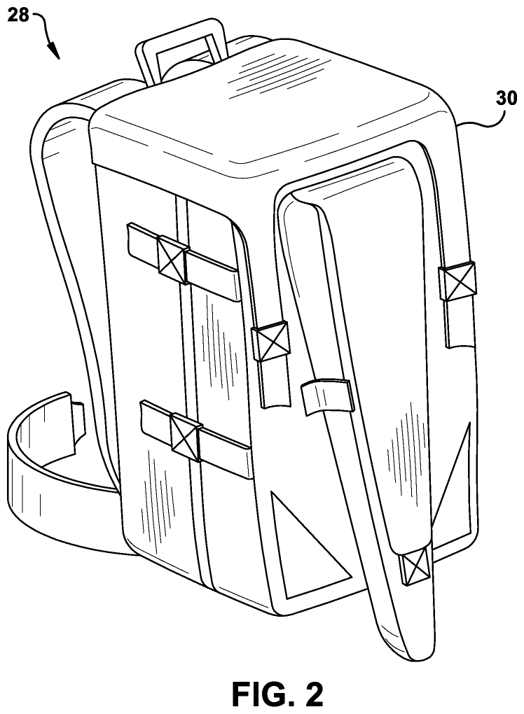

FIG. 2 illustrates an example backpack 28 that employs layers of the Hot Equipment and Thermal Reduction System illustrated in FIG. 1. In an example embodiment, the backpack 28 is constructed from the Heat-RS system 10 illustrated in FIG. 1 and the outer surface 30 of the backpack 28 is the outer layer of the HEAT-RS system 10. In other embodiments, the interior of the backpack comprises the HEAT-RS system 10 and the outer surface 30 is constructed of a different material that interfaces with the outer surface 30 of the HEAT-RS system 10.

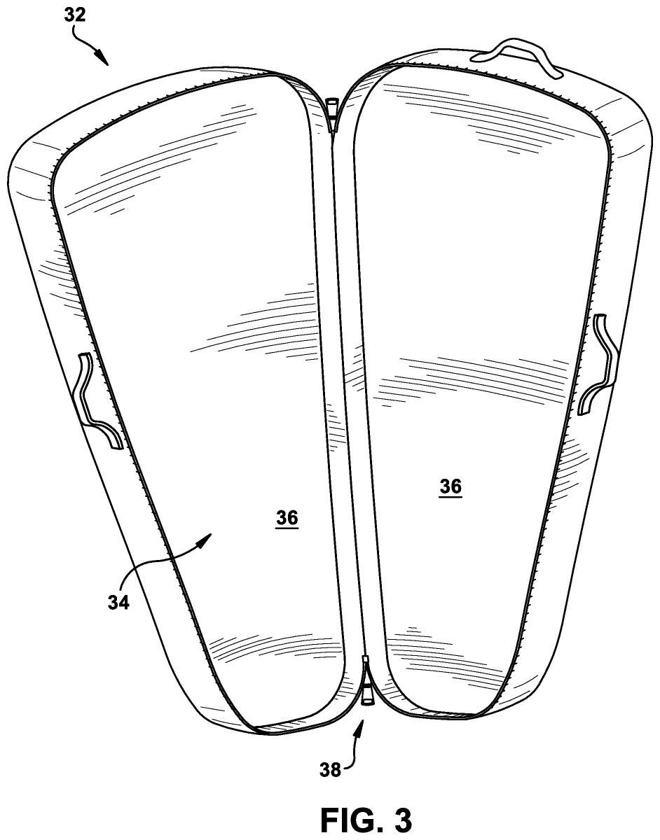

FIG. 3 illustrates an example of a carrying case 32 that employs layers of the Hot Equipment and Thermal Reduction System illustrated in FIG. 1. the carrying case 32 is suitable for carrying firearms or other hot items. The interior 34 of the carrying i 32 case comprises panels (or inserts) 36 suitably comprise hot face contact layer 16 of the HEAT-RS 10, where the remaining layers (e.g., insulating layer 18, reflective layer 20, and optionally outer layer 26 which in particular embodiments is attached to the carrying case 32) are underneath the panels 36. In the illustrated example, the carrying case 32 further comprises a zipper 38. In an example embodiment, the zipper 38 encompasses approximately two-hundred and seventy degrees of the perimeter of the carrying case.

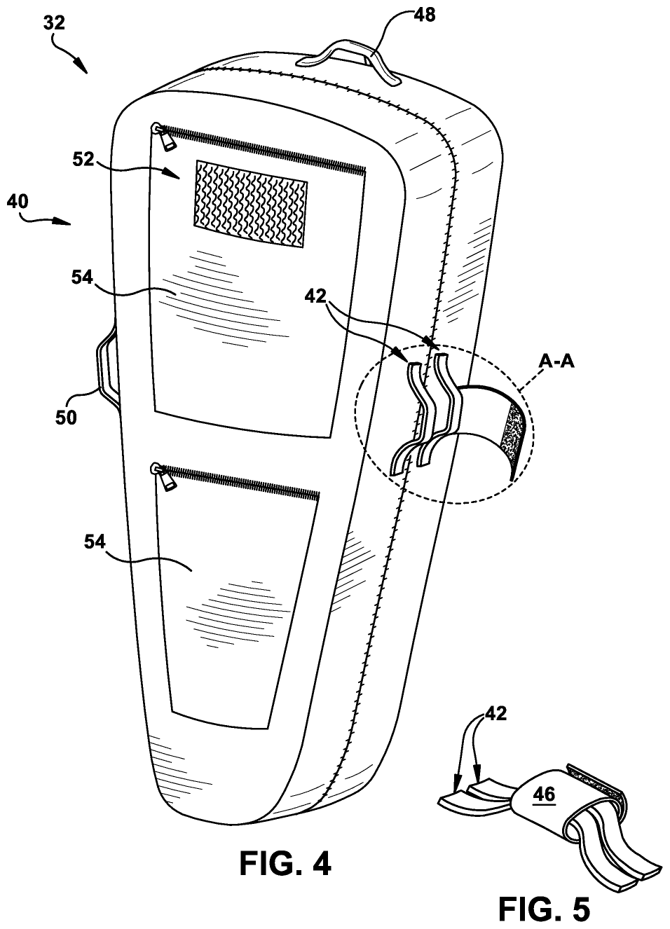

FIG. 4 is an external view of the gun carrying case 32 illustrated in FIG. 3 that shows the carrying case 32 in the closed position. The exterior surface 40 of the carrying case 32 comprises a pair of handles 42 and a hook and loop fastener (such as VELCRO) 44 configured to engage handles 42. An example of the hook and loop fastener 42 engaging the handles 42 is illustrated in FIG. 5, which is an exploded view of the area bounded by circle A-A. In particular embodiments, the carrying case 32 comprises additional handles 48, 50 at the indicated location on exterior surfaced 40 of the carrying case 32. The exterior surface 40 of the carrying case 40 further comprises a second hook and loop fastener 52 and pockets 54 where indicated.

In an example embodiment, the carrying case is configured to carry a firearm such as a rile (not show, see e.g., FIGS. 8-12). The HEAT-RS system 10 is deployed in the interior 34 of the carrying case 32 with the hot face contact layer 16 configured to encompass the contents, such as a rifle, of the carrying case 32 and the outer surface 30 of the HEAT-RS system 10 is adjacent to the exterior 40 of the carrying case 32.

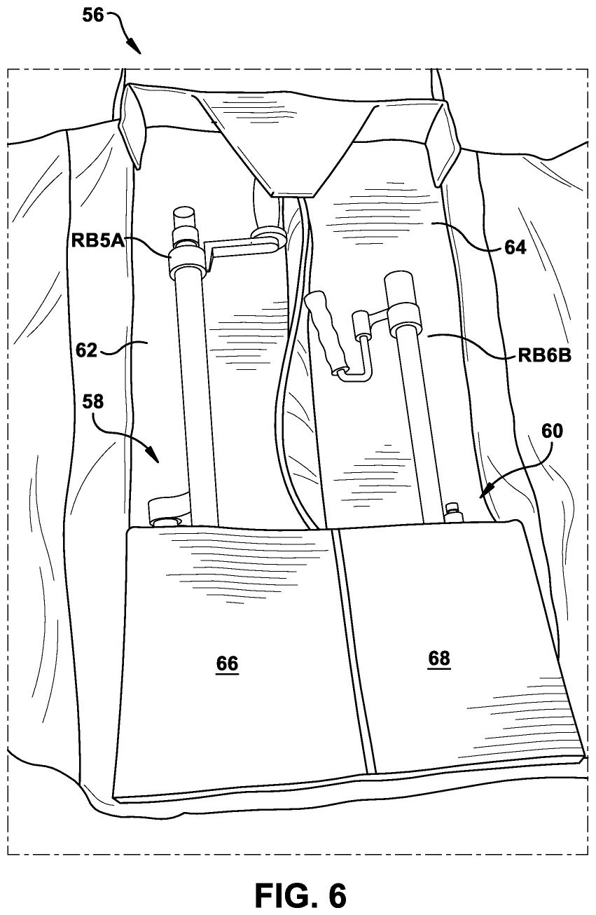

FIG. 6 illustrates an internal view of carrying case 56 with multiple pockets/compartments that employs layers of the Hot Equipment and Thermal Reduction System 10 illustrated in FIG. 1. In the illustrated example, rifle barrels RB6A, RB6B are inserted into pockets 58, 60.

In an example embodiment, the inside of pockets 58, 50 and surfaces 62, 64 comprise a hot face contact layer 16 of the HEAT-RS system 10. Surfaces 66, 68 and surfaces opposing surfaces 62, 64 (not shown) comprise a outer layer 26 of the HEAT-RS system 10. Layers 16, 18 are between surfaces 62, 64 and surfaces 66, 68 respectively.

FIG. 7 illustrates an example of a carrying case 70 configured to carry a rifle that employs layers of the Hot Equipment and Thermal Reduction System illustrated in FIG. 1. Surfaces 72, 74, 76, 78 comprise a hot face contact layer 16 of the HEAT-RS system 10. In particular embodiments, surfaces 72, 76, and optionally 78 are configured to fold around RB7. The opposite side of surfaces 72, 74, 76, 78 comprise an outer layer 26 of the HEAT-RS system 10.

FIG. 8 illustrates another example of a carrying case 80 configured to carry a rile R8 that employs layers of the Hot Equipment and Thermal Reduction System 10 illustrated in FIG. 1. The carrying case comprises inner surfaces 82, 84 that are configured to be adjacent to the rifle R8 and outer surfaces 86, 88 that are on opposite sides of inner surfaces 82, 84 respectively. In an example embodiment, the inner surfaces 82, 84 comprise a hot face contact layer 18 of the HEAT-RS system 10 and the outer surfaces 86, 88 comprise the outer layer 26 of the HEAT-RS system 10. Layers 18, 20 of the HEAT-RS system 10 are between the inner surfaces 82, 84 and the outer surfaces 86, 88 respectively.

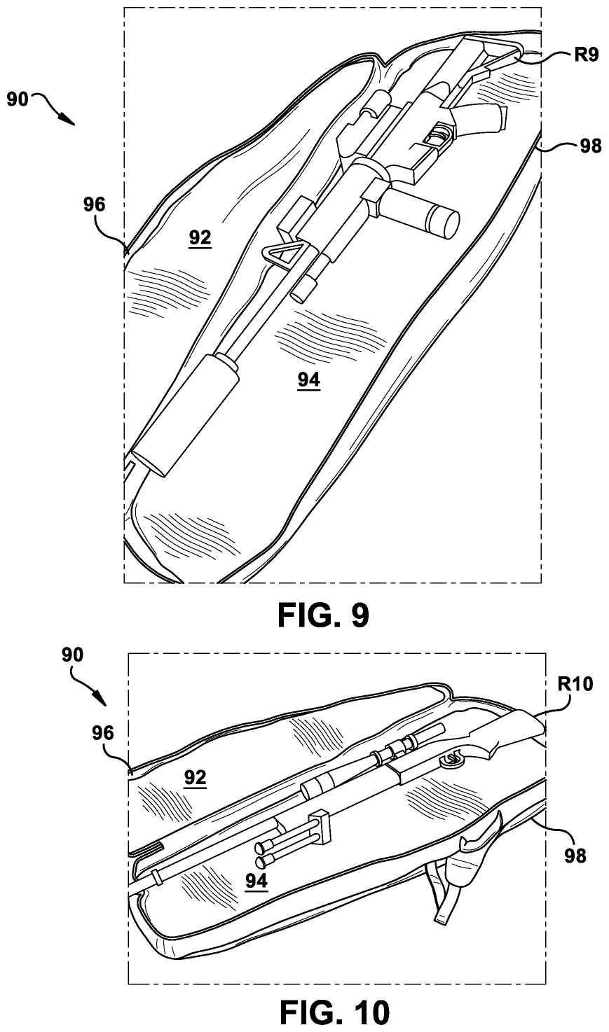

FIG. 9 is a perspective view of yet another example of a carrying case 90 configured to carry a rifle R9 that employs layers of the Hot Equipment and Thermal Reduction System 10 illustrated in FIG. 1. In an example embodiment, inner surfaces 92, 94 are configured to be adjacent to the rifle R9 and comprise the hot fact contact layer 18 described in FIG. 1. Outer surfaces 96, 98 on the outside of the carrying case 90 comprise the outer layer 26 of the HEAT-RS system 10 described in FIG. 1. Layers 18, 20 of the HEAT-RS system 10 are between inner layers 92, 94 and the outer layer 96, 28 respectively.

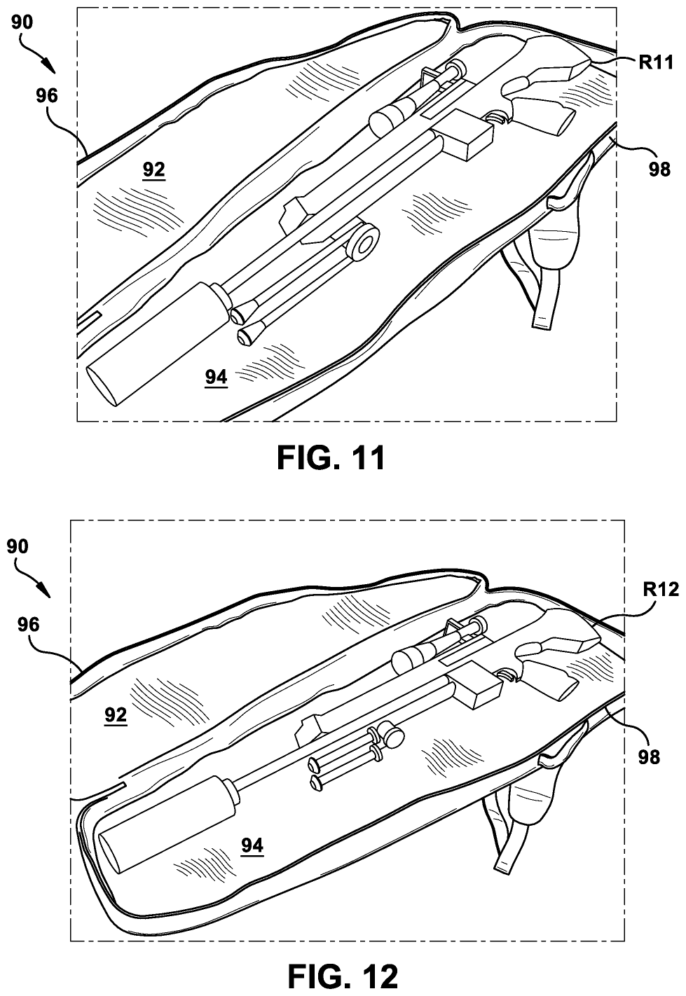

FIG. 10 is another perspective view of the carrying case 90 illustrated in FIG. 9 with rifle R10. FIG. 11 is a perspective view of the carrying case 90 illustrated in FIG. 9 with a different type of rifle R11. FIG. 12 is another perspective view of the carrying case 90 illustrated in FIG. 9 with still yet another rifle R12.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
a hot face contact layer;
an insulating layer coupled with the hot face contact layer; and
a reflective layer coupled with the insulating layer;
wherein the reflective layer is configured to reflect heat back to the insulating layer.

2. The apparatus set forth in claim 1, further comprising an outer layer coupled with the reflective layer.

3. The apparatus set forth in claim 2, wherein the outer layers comprises a material selected from a group consisting of cordura, nylon, cotton, canvas, and a polymer.

4. The apparatus set forth in claim 3, wherein the reflective layer comprises an aluminum material.

5. The apparatus set forth in claim 4, wherein the reflective layer further comprises a material that is bonded with the aluminum material selected from a group consisting of fiberglass, silica, silicon, and Kevlar.

6. The apparatus set forth in claim 5, wherein the insulating layer comprises a material selected from a group consisting of fiberglass, silica, silicon, and Kevlar.

7. The apparatus set forth in claim 6, wherein the material of the insulating layer is formed in a woven pattern, which creates a loose cushion like weave incorporating air pockets in and around the materials

8. The apparatus set forth in claim 1, wherein the hot face contact layer comprises a combination of materials, wherein the combination of materials that comprises a material selected from a group consisting of fiberglass, silica, silicon, Kevlar, and stainless steel.

9. The apparatus set forth in claim 1, wherein the reflective layer comprises an aluminum material.

10. The apparatus set forth in claim 9, wherein the reflective layer further comprises a material that is bonded with the aluminum material selected from a group consisting of fiberglass, silica, silicon, and Kevlar.

11. The apparatus set forth in claim 10, wherein the insulating layer comprises a material selected from a group consisting of fiberglass, silica, silicon, and Kevlar.

12. The apparatus set forth in claim 11, wherein the material of the insulating layer is formed in a woven pattern, which creates a loose cushion like weave incorporating air pockets in and around the materials

13. The apparatus set forth in claim 12, wherein the hot face contact layer comprises a combination of materials that comprises a materials selected from a group consisting of fiberglass, silica, silicon, Kevlar, and stainless steel.

14. The apparatus set forth in claim 1, wherein the apparatus is configured to encapsulate hot equipment, the hot equipment encapsulated by the hot face contact layer.

15. The apparatus set forth in claim 14, wherein the apparatus is configured as a backpack.

16. The apparatus set forth in claim 14, wherein the apparatus is configured to carry a rifle.

17. The apparatus set forth in claim 14, wherein the apparatus is configured to be an insert in a rifle carrying case, the hot face layer configured to be adjacent to the rifle and the outer layer is adjacent to the carrying case.

18. An apparatus, comprising:
a hot face contact layer, the hot face contact layer comprises a combination of materials, wherein the combination of materials comprises a material selected from a group consisting of fiberglass, silica, silicon, Kevlar, and stainless steel;
an insulating layer coupled with the hot face contact layer, the insulating layer comprises a material selected from a group consisting of fiberglass, silica, silicon, and Kevlar;
a reflective layer coupled with the insulating layer, the reflective layer comprises an aluminum material and a material that is bonded with the aluminum material selected from a group consisting of fiberglass, silica, silicon, and Kevlar; and
an outer layer coupled with the reflective layer, the outer layer comprises a material selected from a group consisting of cordura, nylon, cotton, canvas, and a polymer;
wherein the reflective layer is configured to reflect heat back to the insulating layer; and
wherein the material of the insulating layer is formed in a woven pattern, which creates a loose cushion like weave incorporating air pockets in and around the materials.
